(19) United States
(12) Patent Application Publication
(10) Pub. No.: US 2013/0222979 A1
(43) Pub. Date: Aug. 29, 2013

(54) SYSTEM AND METHOD TO OPERATE SHUTTERS

(71) Applicants: Srinivas Salugu, Hyderabad (IN); Sudarshan Allada, Hyderabad (IN); Pravin Pralhad Kulkarni, Hyderabad (IN); Kok-Hann Lew, Chicago, IL (US)

(72) Inventors: Srinivas Salugu, Hyderabad (IN); Sudarshan Allada, Hyderabad (IN); Pravin Pralhad Kulkarni, Hyderabad (IN); Kok-Hann Lew, Chicago, IL (US)

(73) Assignee: GENERAL ELECTRIC COMPANY, Schenectady, NY (US)

(21) Appl. No.: 13/405,389

(22) Filed: Feb. 27, 2012

(51) Int. Cl. H02B 1/14; E06B 9/82; H02B 1/20; E06B 9/68

(52) U.S. Cl. 361/637; 160/405; 160/7

(57) ABSTRACT

In a system with two electronic panels arranged with a plurality of busses between them, the removal of one of the electronic panels exposes the live busses to a user. To shield the user from the exposed busses, a mechanism operates shutters to close and cover the busses. The mechanism operation can be based on the rotation of a cam supporting the shutters in the open position. A manual override allows the shutters to be kept in the open position even when the busses are exposed due to the removal of an electronic panel.

### BACKGROUND OF THE INVENTION

The subject matter disclosed herein relates to a shutter mechanism in an automatic transfer switch system.

An automatic transfer switch (ATS) is an electrical switch that reconnects an electric power source from a primary to a secondary source. That is, the ATS connects a load to backup power in a case of maintenance or malfunction of the primary power source. A bypass power panel acts as a manual transfer switch and provides redundancy during maintenance or repair to the ATS. The ATS and bypass power panel are typically housed in a frame or rack with a plurality of busses. A shutter mechanism acts as a barrier that prevents a user from coming into contact with a live bus when the ATS is removed. In prior systems, shutter mechanisms have generally moved horizontally across the body of the frame, even when the busses are arranged horizontally. This arrangement presents disadvantages, especially in arrangements with space constraints, because the shutter mechanism must extend beyond the body of the frame. Disadvantages can also arise when the mechanism to operate the shutter lacks consistent movement that mitigates jamming.

### BRIEF DESCRIPTION OF THE INVENTION

According to one aspect of the invention, a system includes a first electronic panel arranged at a first side of a frame; a second electronic panel arranged at a second side, opposite to the first side, of the frame; a plurality of busses between the first electronic panel and the second electronic panel and configured to be connected to the first electronic panel and the second electronic panel, the plurality of busses being arranged in a first orientation; a shutter arranged to cover the plurality of busses by moving in a second orientation, perpendicular to the first orientation; and a mechanism configured to close the shutter to cover the plurality of busses, the mechanism comprising a cam that rotates to affect movement of the shutter in the second orientation.

According to another aspect of the invention, a mechanism operates one or more shutters in a system comprising two electronic panels arranged on opposite sides of a plurality of busses that are arranged in a first orientation. The mechanism includes a cam configured to support the one or more shutters in an open position when the two electronic panels are present, the shutters being configured to move in a second orientation perpendicular to the first orientation; a bracket holding the cam, the bracket being configured to move when one of the electronic panels is disengaged from the plurality of busses; and an actuator configured to rotate the cam to release the one or more shutters so that the one or more shutters move in the second orientation to a closed position covering the plurality of busses based on movement of the bracket.

According to yet another aspect of the invention, a method of operating one or more shutters in a system comprising two electronic panels arranged on opposite sides of a plurality of busses that are arranged in a first orientation includes positioning a cam to support the one or more shutters in an open position when the two electronic panels are present; and rotating the cam to move the shutters in a second orientation, perpendicular to the first orientation, to a closed position covering the plurality of busses when one of the two electronic panels is disengaged from the plurality of busses.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a power switching system according to an embodiment of the invention;

FIG. 2 shows the shutter mechanism from a perspective of the ATS power panel and components of the mechanism according to an embodiment of the invention;

FIG. 3 shows the shutter mechanism from a perspective of the bypass power panel and components of the mechanism according to an embodiment of the invention; and

FIG. 4 shows the processes included in controlling the shutters according to an embodiment of the invention.

The detailed description explains embodiments of the invention, together with advantages and features, by way of example with reference to the drawings.

### DETAILED DESCRIPTION OF THE INVENTION

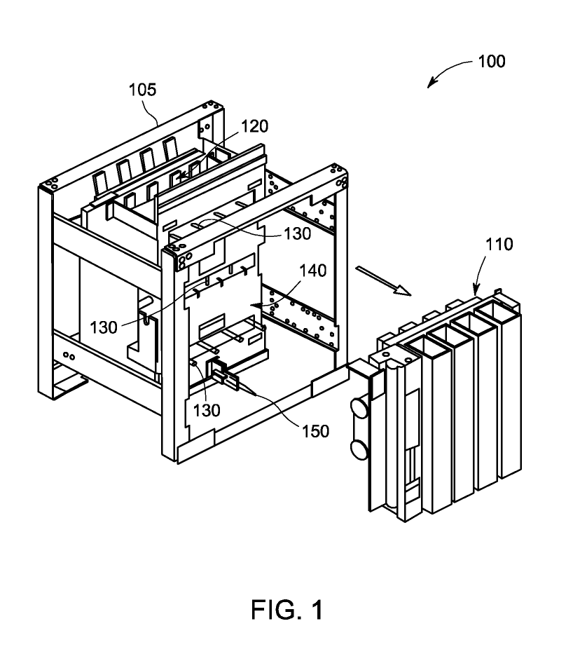

FIG. 1 illustrates a power switching system 100 according to an embodiment of the invention. The frame 105 holds an ATS power panel 110, a bypass power panel 120, busses 130, shutters 140, and a shutter mechanism 150. A power switching system 100 is discussed herein as an exemplary system. The power switching system 100 includes an ATS power panel 110 and a bypass power panel 120 (switching panels 110, 120). However, it is to be understood that the shutters 140 and mechanism 150 are suitable and advantageous for use with any system that includes any type of electronic panels (such as the switching panels 110, 120) and that benefits from covering live busses 130 during maintenance or replacement of one of the switching panels 110, 120.

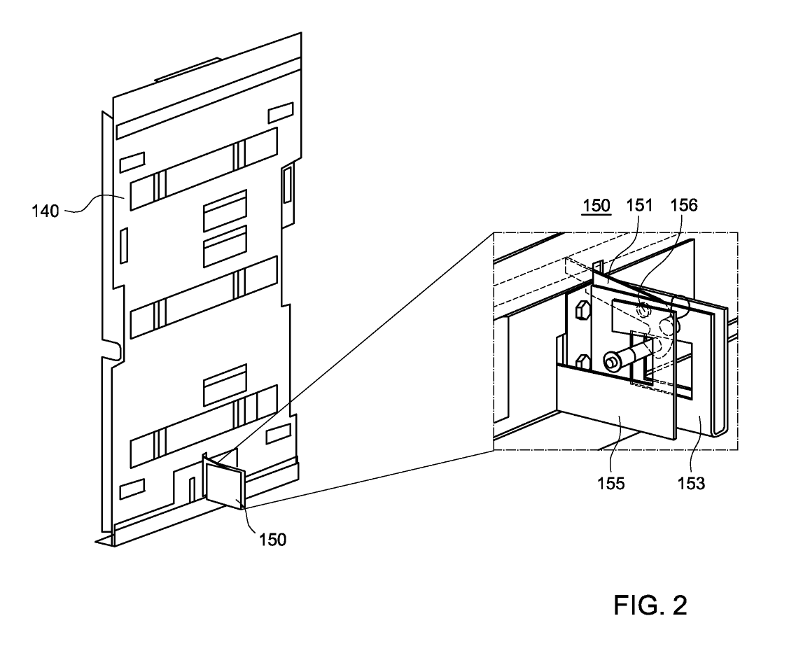

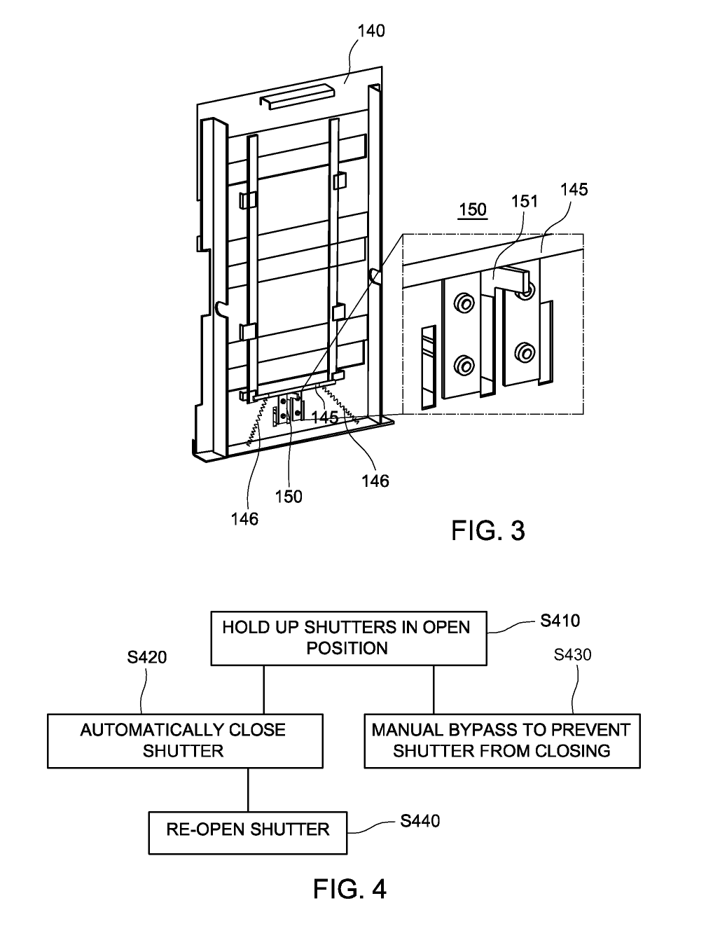

The ATS power panel 110 can be pulled forward, as shown at FIG. 1, to remove the ATS power panel 110 from the frame 105 for maintenance or replacement. As FIG. 1 shows, removing the ATS power panel 110 from the frame 105 leaves the busses 130 exposed. As shown at FIG. 1, the system 100 includes three sets of the busses 130 and each of the three sets of busses 130 is arranged horizontally. The exposed live busses 130 can present a hazard to a user accessing the frame 105. The shutters 140 are shown in the closed position, but when the shutters are open, they reveal the busses 130. The shutters 140 shown in FIG. 1 would move down to cover/uncover the busses 130. The shutters 140 are referred to in the plural because each piece covers a different set of busses 130. However, as is clearer in FIGS. 2 and 3, the shutters 140 may be comprised of a single piece of material with slits cut out to expose each set of busses 130 in the open position.

The mechanism 150 that operates the shutters 140 is discussed in greater detail below. The mechanism 150 is configured to automatically force the shutters 140 into a closed position (covering the busses 130) when the ATS power panel 110 is removed. Specifically, in the embodiment shown at FIG. 1, the shutters 140 would move downward to cover the busses 130. In order to prevent the automatic covering of the busses 130 by the shutters 140, a manual override of the mechanism 150 is possible. This manual override would be used by a technician who wished to access the busses 130 as part of a system 100 check, for example. Once the ATS power panel 110 is ready to be replaced in the frame 105, the shutters 140 could be raised by the mechanism 150 to expose the busses 130 so that the ATS power panel 110 could connect to the busses 130.

FIG. 2 shows the shutter mechanism (shutters 140, mechanism 150) from a perspective of the ATS power panel 110 and components of the mechanism 150 according to an embodiment of the invention. The components include a cam 151, bracket 153, an actuator 155, and a hole 156. The actuator 155 causes the cam 151 to rotate from the position shown at FIG. 2 to close the shutters 140. The actuator 155 is affected by the motion of the ATS power panel 110 as it gets pulled away and out of the frame 105. The actuator 155 gets pulled from the bracket 153, thereby allowing the cam 151 to rotate in a way that pulls down the shutters 140 with its rotation. In this way, the shutters 140 can be closed automatically with the removal of the ATS power panel 110. If the busses 130 need to be accessed, a pin can be placed through the hole 156 to force the cam 151 to maintain its position and hold the shutters 140 in the open position even if the ATS power panel 110 is removed. This manual override of the mechanism 150 may be used by a technician who needs to check the busses 130 themselves.

FIG. 3 shows the shutter mechanism (shutters 140, mechanism 150) from a perspective of the bypass power panel 120 and components of the mechanism 150 according to an embodiment of the invention. The perspective illustrated by FIG. 3 shows the shutter bar 145 resting on the cam 151 when the shutters 140 are in the open position. When the cam 151 rotates down, the shutter bar 145 slides down so that the shutters 140 move down and cover the busses 130. This downward action of the shutters 140 may be aided by two springs 146, one on each side of the shutter bar 145, that extend when the shutter bar is held up by the cam 151 and relax to pull down the shutters 140 when the cam 151 rotates down. To re-expose the busses 130, in order to re-attach the ATS power panel 110, for example, the cam 151 can be rotated back up to the position shown by FIGS. 2 and 3 so that it holds the shutter bar 145 in the open position again.

FIG. 4 shows the processes included in controlling the shutters 140 according to an embodiment of the invention. At block S410, holding up the shutters 140 in an open position includes resting the shutter bar 145 on the cam 151 of the mechanism 150. This could be seen as a default position when both the ATS power panel 110 and the bypass power panel 120 are in the frame 105. At S420, automatically closing the shutters 140 includes the actuator 155 being moved based on the removal of the ATS power panel 110 from the frame 105 so that the cam 151 rotates down, thereby releasing the shutter bar 145 and closing the shutters 140 over the busses 130. When the ATS power panel 110 is replaced in the frame 105, re-opening the shutters 140 at block S440 includes rotating the cam 151 of the mechanism 150 back up to reposition the shutter bar 145 in a position to open the shutters 140 and expose the busses 130. Alternatively to automatically closing the shutters 140 upon removal of the ATS power panel 110 from the frame 105, a pin could be placed in the hole 156 of the mechanism 150 to manually bypass the closing of the shutters 140 upon removal of the ATS power panel 110 from the frame 105 at block S430. As shown by FIG. 2, the hole 156 is through both the cam 151 and the bracket 153 such that a pin placed in the hole 156 would prevent relative movement between the cam 151 and bracket 153.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system comprising:
a first electronic panel arranged at a first side of a frame;
a second electronic panel arranged at a second side, opposite to the first side, of the frame;
a plurality of busses between the first electronic panel and the second electronic panel and configured to be connected to the first electronic panel and the second electronic panel, the plurality of busses being arranged in a first orientation;
a shutter arranged to cover the plurality of busses by moving in a second orientation, perpendicular to the first orientation; and
a mechanism configured to close the shutter to cover the plurality of busses.

2. The system according to claim 1, wherein the mechanism comprises a cam that rotates to affect movement of the shutter in the second orientation.

3. The system according to claim 2, wherein the mechanism further comprises an actuator that causes the cam to rotate, without human intervention, and close the shutter to cover the plurality of busses when the first electronic panel is removed from the frame and the plurality of busses is exposed to a user.

4. The system according to claim 3, wherein the mechanism further comprises a bracket that holds the cam and is configured to cause the actuator to cause the cam to rotate when the first electronic panel is removed from the frame and the plurality of busses is exposed.

5. The system according to claim 2, further comprising a shutter bar that rests on the cam when the shutter is in an open position.

6. The system according to claim 5, wherein the shutter bar moves in the second orientation within the frame based on rotation of the cam, and the shutter moves in correspondence to the movement of the shutter bar.

7. The system according to claim 2, further comprising a manual override configured to prevent the mechanism from closing the shutter when the first electronic panel of the second electronic panel is removed from the frame.

8. The system according to claim 7, wherein the manual override comprises a pin placed in a hole within the cam.

9. The system according to claim 1, further comprising two or more sets of the plurality of busses, each of the two or more sets of the plurality of busses being arranged in the first orientation.

10. The system according to claim 8, further comprising two or more shutters configured to move in the second orientation, each of the two or more shutters covering a corresponding one of the two or more sets of the plurality of busses.

11. The system according to claim 1, wherein the first electronic panel is an automatic transfer switch (ATS) power panel and the second electronic panel is a bypass power panel.

12. A mechanism to operate one or more shutters in a system comprising two electronic panels arranged on opposite sides of a plurality of busses that are arranged in a first orientation, the mechanism comprising:
a cam configured to support the one or more shutters in an open position when the two electronic panels are present, the shutters being configured to move in a second orientation perpendicular to the first orientation;
a bracket holding the cam, the bracket being configured to move when one of the electronic panels is disengaged from the plurality of busses; and
an actuator configured to rotate the cam to release the one or more shutters so that the one or more shutters move in the second orientation to a closed position covering the plurality of busses based on movement of the bracket.

13. The mechanism according to claim 12, further comprising a manual override to prevent the one or more shutters from moving to the closed position.

14. The mechanism according to claim 13, wherein the manual override includes a pin through a hole in the cam and the bracket.

15. A method of operating one or more shutters in a system comprising two electronic panels arranged on opposite sides of a plurality of busses that are arranged in a first orientation, the method comprising:
positioning a cam to support the one or more shutters in an open position when the two electronic panels are present; and
rotating the cam to move the one or more shutters in a second orientation, perpendicular to the first orientation, to a closed position covering the plurality of busses when one of the two electronic panels is disengaged from the plurality of busses.

16. The method according to claim 15, further comprising manually overriding the rotating the cam to hold the shutters in the open position when one of the two electronic panels is disengaged from the plurality of busses.
